(19) United States
(12) Patent Application Publication
(10) Pub. No.: US 2003/0161343 A1
(43) Pub. Date: Aug. 28, 2003

(54) Transmission procedures

(76) Inventor: Amitava Ghosh, Vernon Hills, IL (US)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 10/311,912

(22) PCT Filed: Jun. 27, 2001
(86) PCT No.: PCT/IB01/01177

(30) Foreign Application Priority Data
Jun. 30, 2000 (GB) 0015976.4

(51) Int. Cl. H04J 3/16

(52) U.S. Cl. 370/465

(57) ABSTRACT

Method and system for selecting the most suitable logic channel for transmitting packet data in a third generation cellular communications system enables a radio network controller (102) to set bit rate, spread factor and frames required from information supplied by user equipment (104) and the node B's (110) comprising the system. Such information comprises queue size, reported by the user equipments, and noise rise measurements due to user equipment activity, reported by the node B's. The invention advantageously allows a logic channel to be chosen based on the prevailing system state conditions. Hence performance of the system is optimised.

### FIELD OF THE INVENTION

This invention relates to transmission procedures in cellular communications systems. More particularly, this invention relates to the selection of procedures for the transmission of data packets in third generation cellular communications systems.

### BACKGROUND OF THE INVENTION

Wireless communications systems typically comprise a number of radios, which may be linked in a variety of ways. These ‘radios’ may be mobile phones. They may alternatively be mobile or portable radios, usually referred to as ‘PMR’ radios. The term mobile station (MS) will be used henceforth for mobile telephones and portable- or mobile radios.

The mobile stations may communicate through base stations of the system. Each base station typically serves a cell of the wireless communications system. The base stations offer interconnection either to the fixed line telephone system (‘POTS’), or to other mobile stations in the system. Mobiles that communicate through base stations may or may not be in the same cell of the network. Alternatively, mobile. stations may communicate directly with one another, in ‘direct mode’ communication.

In third generation partnership project (3GPP) wideband code division multiple access (WCDMA) systems and other such third generation (3G) systems, there are various methods which may be utilised for the transmission of packet data for both uplink and downlink. The communication between a mobile subscriber or user equipment (UE) and a network is termed uplink and between the network and the UE is termed downlink. These may be found in the latest 3GPP specification.

Currently, three kinds of transport/logical channel are provided for uplink packet transmission. These channels enable the transmission of packets from the UE to the network. The first channel is the random access channel (RACH), the second is the common packet channel (CPCH) or enhanced access channel (for CDMA 2000) and the third is the dedicated channel (DCH).

Similarly, there are currently two kinds of transport logic channel provided for downlink packet transmission. These are the forward access channel (FACH) and the downlink shared channel (DSCH). The latter of these two is associated with the dedicated channel (DCH) for downlink.

At the present time, a network or system has no knowledge of which procedure should be invoked by the Radio Network Controller (RNC) for an uplink or downlink packet data transfer. As such, it is not possible for the system to utilise the most suitable channel or procedure without being instructed which channel is the most suitable. There is thus a problem in that the system is unable to optimise its performance. Additionally, there is no provision in the 3GPP specifications which provides for a procedure enabling selection of an appropriate packet data transfer procedure.

The present invention addresses one or more of the above disadvantages.

### SUMMARY OF THE INVENTION

According to a first aspect of the invention, there is provided a method of selecting a transmission procedure for transmitting queued data packets in a cellular communications system, characterised by the steps of; a user equipment (UE) transmitting a measurement report message to a radio network controller (RNC);

a node B computing noise rise and reporting it to the RNC;

the RNC computing a bit rate, a corresponding spread factor (SF) and a number of frames required to transmit the queued packets; and

the RNC determining (204) the most appropriate channel to transmit upon.

According to a second aspect of the invention there is provided an apparatus for selecting a transmission procedure for transmitting queued data packets in a cellular communications system the apparatus including; a node B, a radio network controller and a user equipment for transmitting a measurement report to the radio network controller (RNC) and characterised in that the node B is adapted to compute a noise rise and report it to the RNC and the RNC is adapted to compute a bit rate, a corresponding spread factor and a number of frames required to transmit the queued data packets and to determine the most appropriate channel to transmit on.

If a uni-directional transmission on uplink is required, each mobile subscriber or user equipment requiring uplink sends a measurement report message relating to packet queue size, associated quality of service requirements, pilot strength and number of fingers locked.

If a unidirectional transmission on downlink is required, the BTS [Node B] from which the downlink transmission is to originate computes the size of a packet data queue and then measures an amount of unused linear power amplifier (LPA) capacity available to it.

Similarly, if a bidirectional transmission is required, a dedicated channel (DCH) may be used on uplink and a dedicated shared channel (DSCH) in association with the dedicated downlink channel (DCH) may be used on downlink irrespective of the size of the queue of packet data awaiting transmission.

### BRIEF DESCRIPTION OF THE DRAWINGS

Embodiments of the present invention will now be described, by way of example only, with reference to the drawings of which:

FIG. 1 depicts the interaction between a 3G cellular communications network and its users;

FIG. 2 shows a flow diagram illustrating the selection of transmission procedure for a uni-directional packet data transfer on uplink in accordance with the present invention;

FIG. 3 shows a flow diagram illustrating the selection of transmission procedure for a uni-directional packet data transfer on downlink in accordance with the present invention;

FIG. 4 illustrates the general scheme of a wireless communications system 10 operating in accordance with the present invention; and

FIG. 5 illustrates a mobile station (MS) for use in the system of Figure

### DESCRIPTION OF THE PREFERRED EMBODIMENTS

As may be seen in FIG. 1, in a third generation cellular communications system, a radio network controller (RNC) 102 communicates with a number (I to k) of BTS's [or Node B's] which in turn communicate with a number (1 to n) of users 104,106,108 known as user equipment (UE). The user equipment may be a mobile telephone, laptop computer, paging device, etc. Communication takes place through a source node B 110. Each source node B is a component of the network and is in communication with the RNC. These elements equate to the base station controller-(BSC), mobile station or subscriber (MS) and base transceiver station (BTS) of a global mobile communications system (GSM) or general packet radio system (GPRS).

The method of selecting an appropriate transmission procedure depends upon the type of transmission required. The available types of transmission may be expressed as i) uni-directional packet data transfer on uplink, ii) uni-directional packet data transfer on downlink, and iii) bi-directional packet data transfer on uplink and downlink. The RNC is aware of the type of transmission to be carried out because it is either initiating transmission, or is involved in the allocation of resource for a requested uplink. As such, the selection of transmission procedure is carried out in accordance with the type of transmission to be made. The selection for each type of transmission is described in detail below.

The choice of logical channel to be utilised in packet data transfer, whilst dependent upon the type of transmission to be made (as detailed above), is primarily dependent upon a number of factors. These factors include the queue size at the UE or at the RNC for a particular UE, i.e. the number of data packets awaiting transmission, the quality of service (QoS) requirements associated with the queued data packets, the number of voice and data users currently using the system, the location of those users, the current level of interference being experienced and the LPA capacity, etc.

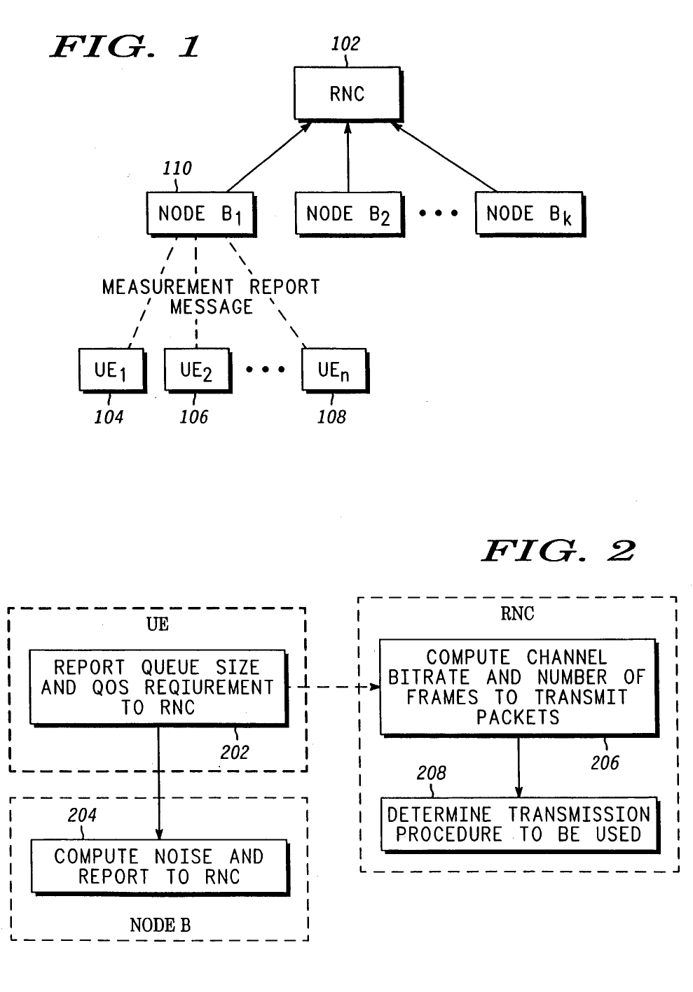

The choice of logical channel for unidirectional packet data transfer on uplink is detailed with regard to FIG. 2. Function box 202 shows the step of a UE sending a measurement report message to an RNC via a source node B. The measurement report message comprises queue size information, QoS requirements of the packets accumulated at the UE the number of locked fingers and pilot strength measurement messages, etc. This step is carried out by each UE currently operating within the system which requires uplink. Function box 204 details the step of each node B, which is handling within its area of operation a UE requiring uplink, computing the noise rise (increase in noise) which it experiences due to UE activity and reporting this value to the RNC. As stated previously, the node B in a 3G system is equivalent to the BTS in a GSM or GPRS system. As such, each node B is responsible for the UEs within its' specified area (the area of the cell within which it operates).

When all the above information has been received, the RNC computes the information/channel bit rate, the SF and the number of data frames which will be required in order to transmit the queued data packets at the computed rate. These values are calculated based upon the queue size (function box 206) and other system information such as noise rise, etc. Data is transmitted using physical channels at an information bit rate computed at the RNC for a predetermined number of frames to the destination device. Each frame has a specific duration and comprises a number of time slots which may be utilised for transmission by the UE or node B in uplink and downlink.

Function box 208 shows an example step of the RNC determining which of the three logical channels suitable for use in uplink should be utilised. Such determination is carried out in accordance with the following sequential conditions:

Condition 1:

| | | | | | |
|---|---|---|---|---|---|
| IF | number of | < T₁ AND | Channel | < R₁ USE | Random Access |
| | frames | | bit rate | | Channel |
| | required to | | | | (RACH) |
| | transmit | | | | |
| | packets | | | | |

wherein T₁. and R₁. are thresholds, the values of which are implementation dependent and are set by the system operator in the RNC.

Condition 2:

| | | | | | |
|---|---|---|---|---|---|
| IF T₁ | < | number of | < T₂ AND R₁ | < channel | < R₂ |
| | | frames | | bit rate | |
| | | required to | | | |
| | | transmit | | | |
| | | packets | | | |
| AND | Noise | < I₁ AND | Number of | < V₁ USE | Common |
| | rise at | | voice users | | Packet |
| | target | | | | Channel |
| | node B | | | | (CPCH) or |
| | | | | | Enhanced |
| | | | | | Access |
| | | | | | Channel |
| | | | | | (EACH) |

again, T₁, T₂. R₁, R₂. I₁ and V₁ are thresholds, the values of which are implementation dependent and are system operator defined. Additionally, T₂>T₁ and R₂>R₁.

Condition 3:

| | | | |
|---|---|---|---|
| IF | neither of conditions 1 or 2 are | USE | Dedicated Channel (DCH) |
| | met | | |

The above conditions show a typical way of determining which logical channel is to be used for transferring data packets on uplink. Thresholds therein are set to values which ensure that RACH is used for short messages or transmissions (1 or 2 frames for example), CPCH or EACH is used for medium length messages or transmissions (3 to 10 frames for example) and DCH is used for long messages or transmissions (>10 frames for example).

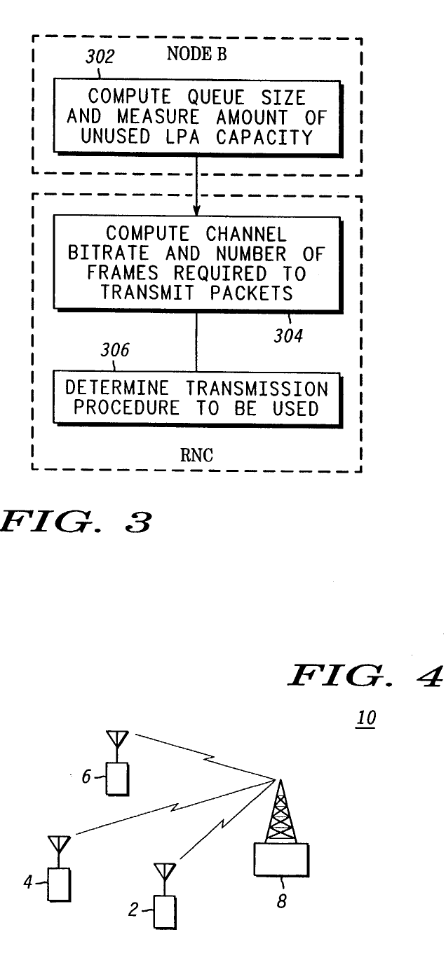

The choice of logical channel for uni-directional packet data transfer on downlink is illustrated in FIG. 3. As may be seen, for downlink, the packets to be transmitted queue up at the RNC for the particular user. The Node B computes the queue size and measures the amount of unused linear power amplifier (LPA) capacity, which it then forwards to the RNC. The LPA is a hardware component of the system which resides within node B.

Function box 304 depicts the step of the RNC utilising the provided information (in the form of queue size) to compute the channel bit rate and the number of frames required in order to transmit the queuing data packets. This information is then used in the following condition to determine which of the two logic channels available for downlink should be used (function box 306):

| | | | |
|---|---|---|---|
| IF | number of | < T₃ AND | channel < R₃ |
| | frames | | bit rate |
| | required to | | |
| | transmit | | |
| | packets | | |
| USE | Forward | OTHERWISE USE | Dedicated Shared Channel |
| | Access | | (DSCH) in association with |
| | Channel | | Decicated Channel (DCH) |
| | (FACH) | | |

once again, T₃ and R₃ are implementation dependent thresholds, the values of which are set by the system operator.

The above condition ensures that FACH is used for shorter duration transmissions (1 to 2 frames for example) and that DSCH (in association with downlink DCH) is used for longer duration transmissions (greater than 2 frames for example).

The final type of transmission that may be utilised is bi-directional packet data transfer on uplink and downlink. When such a transmission is to be initiated, no determination of transmission procedure to be used needs to be carried out. In this instance, DCH should always be used on uplink, and DSCH associated with a DCH should always be used on downlink, utilising a rapid initialisation procedure for packet data transfer, regardless of queue size. Rapid initialisation procedure is a procedure which involves the termination of the dedicated channel when no data requires transmission, and its associated rapid restart when data next requires transmission. Similarly, this allows for transmission of packets in bursts.

The above methodology has the advantage of ensuring that the most appropriate and suitable logic channel is utilised for the transmission of data packets whether on uplink or downlink, and whether the transmission is to be unidirectional or bidirectional. The logic channel is generally chosen in view of the prevailing system state and conditions, in order to refine the choice and optimise the system performance.

In addition to the method described above, there is provided a system comprising the means to carry out that method, thereby achieving the advantages inherent therein.

FIG. 4 illustrates the general scheme of one example of a wireless communications system 10 in accordance with the present invention. Mobile stations 2, 4 and 6 of FIG. 4 can communicate with a base station 8. Mobile stations 2, 4 and 6 could be mobile telephones. Alternatively, they could be PMR radios, i.e. portable radios or mobile radios mounted in vehicles.

Each of the mobile stations shown in FIG. 4 can communicate through base station 8 with one or more other mobile stations. If mobile stations 2, 4 and 6 are capable of direct mode operation, then they may communicate directly with one another or with other mobile stations, without the communication link passing through base station 8.

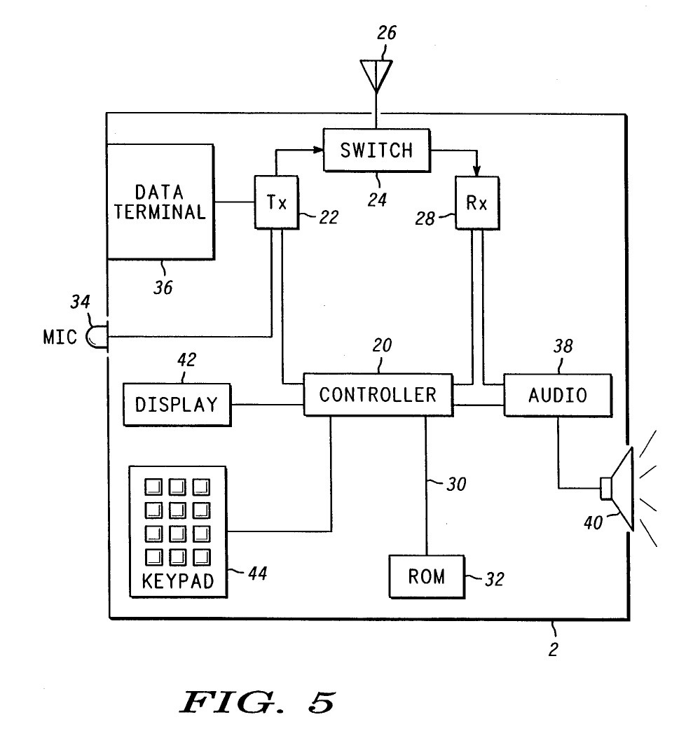

FIG. 5 illustrates a mobile station (MS) operating in accordance with the present invention. The mobile station (MS) of FIG. 5 is a radio communication device, and may be either a portable-or a mobile radio, or a mobile telephone.

The mobile station 2 of FIG. 5 can transmit speech from a user of the mobile station. The mobile station comprises a microphone 34 which provides a signal for transmission by the mobile station. The signal from the microphone is transmitted by transmission circuit 22. Transmission circuit 22 transmits via switch 24 and antenna 26.

Mobile station 2 also has a controller 20 and a read only memory (ROM) 32. Controller 20 may be a microprocessor.

ROM 32 is a permanent memory, and may be a non-volatile Electrically Erasable Programmable Read Only Memory (EEPROM). ROM 32 is connected to controller 20 via line 30.

The mobile station 2 of FIG. 5 also comprises a display 42 and keypad 44, which serve as part of the user interface circuitry of the mobile station. At least the keypad 44 portion of the user interface circuitry is activatable by the user. Voice activation of the mobile station may also be employed. Similarly, other means of interaction with a user may be used, such as for example a touch sensitive screen.

Signals received by the mobile station are routed by the switch to receiving circuitry 28. From there, the received signals are routed to controller 20 and audio processing circuitry 38. A loudspeaker 40 is connected to audio circuit 38. Loudspeaker 40 forms a further part of the user interface.

A data terminal 36 may be provided. Terminal 36 would provide a signal comprising data for transmission by transmitter circuit 22, switch 24 and antenna 26. Data received by receiving circuitry 28 may also be provided to terminal 36. The connection to enable this has been omitted from FIG. 5 for clarity of illustration.

It will be appreciated that although this method has been described with reference to wideband code division multiple access (WCDMA) systems, it applies equally to other third generation cellular communications systems, including universal mobile telecommunications systems (U MTS).

It will of course be understood that the present invention has been described by way of example only, and that modifications of detail can be made within the scope of the appended claims.

1. A method of selecting a transmission procedure for transmitting queued data packets in a cellular communications system, characterised by the steps of a user equipment (UE) transmitting (202) a measurement report message to a radio network controller (RNC);
a node B capacity (204) noise rise and reporting it to the RNC;
the RNC computing (204) a bit rate, a corresponding spread factor (SF) and a number of frames required to transmit the queued packets; and
the RNC determining (204) the most appropriate channel to transmit upon.

2. A method as claimed in claim 1, wherein the measurement report message includes packet queue size, associated quality of service (QoS) requirements, pilot strength and number of fingers locked.

3. A method as claimed in claim 2, wherein the bit rate, the spread factor (SF) and the number of frames are calculated from the packet queue size.

4. A method as claimed in claim 3, wherein the transmission procedure is chosen in accordance with at least one condition.

5. A method as claimed in claim 4, wherein the following conditions are utilised:
Condition 1:

| | | | | |
|---|---|---|---|---|
| IF | number of | < T₁ AND bit rate < R₁ | USE | Random Access |
| | frames | | | Channel (RACH) |
| | required to | | | |
| | transmit | | | |
| | packets | | | |

Condition 2:

| | | | | | |
|---|---|---|---|---|---|
| IF | T₁ < | number of | < T₂ AND R₁ | < bit rate | < R₂ |
| | | frames | | | |
| | | required to | | | |
| | | transmit | | | |
| | | packets | | | |
| AND | Noise | < I₁ AND | Number of | < V₁ USE | Common |
| | rise at | | voice users | | Packet |
| | target | | | | Channel |
| | node B | | | | (CPCH) or |
| | | | | | Enhanced |
| | | | | | Access |
| | | | | | Channel |
| | | | | | (EACH) |

Condition 3:

| | | | |
|---|---|---|---|
| IF | Neither of conditions 1 or 2 are | USE | Dedicated Channel (DCH) |
| | met | | |

wherein T₁, T₂, R₁, R₂, i₁ and V₁, are implementation dependent thresholds.

6. A method as claimed in claim 1, further comprising the steps of the node B computing (302) the size of a queue of packet data waiting for a particular UE and measuring (302) an amount of unused linear power amplifier (LPA) capacity, and a number of voice users;

7. A method as claimed in claim 6, wherein the transmission procedure is chosen in accordance with at least one condition.

8. A method as claimed in claim 7, wherein the following condition is utilised:

| | | | | |
|---|---|---|---|---|
| IF | Number of | < T₃ | AND | bit rate < R₃ |
| | frames | | | |
| | required to | | | |
| | transmit | | | |
| | packets | | | |
| USE | Forward | OTHERWISE | USE | Dedicated Shared Channel |
| | Access | | | (DSCH) in association with |
| | Channel | | | Dedicated Channel (DCH) |
| | (FACH) | | | |

wherein T₃ and R₃ are implementation dependent thresholds.

9. A method as claimed in claim 1, wherein if a bidirectional transmission is required, a dedicated channel (DCH) is used on uplink and a dedicated shared channel (DSCH) in association with the DCH is used on downlink, irrespective of a queue size of packet data awaiting transmission.

10. A method as claimed in claim 9, further comprising the use of a rapid initialisation procedure in association with packet data transfer on DCH and DSCH.

11. Apparatus for selecting a transmission procedure for transmitting queued data packets in a cellular communications system the apparatus including; a node B, a radio network controller
and user equipment (104) for transmitting a measurement report to the radio network controller (102) (RNC)
and characterised in that node B (110) is adapted to compute noise rise and report it to the RNC (102)
and the RNC 102) is adapted to compute a bit rate, a corresponding spread factor and a number of frames required to transmit the queued data packets and to determine the most appropriate channel to transmit on.
